(19) United States
(12) Patent Application Publication
(10) Pub. No.: US 2003/0131626 A1
(43) Pub. Date: Jul. 17, 2003

(54) Arrangement for improving the homogeneity of the refractive index of quartz glass objects

(75) Inventors: Lars Ortmann, Jena (DE); Matthias Schmidt, Jena (DE); Gordon von der Gonna, Jena (DE); Rolf Martin, Jena (DE)

Correspondence Address: JORDAN AND HAMBURG LLP, 122 EAST 42ND STREET, SUITE 4000, NEW YORK, NY, 10168, US

(73) Assignee: Schott Glas, Mainz (DE)

(21) Appl. No.: 10/262,395

(22) Filed: Oct. 1, 2002

(30) Foreign Application Priority Data
Oct. 8, 2001 (DE) 101 49 655.9

(51) Int. Cl. C03B 19/06

(52) U.S. Cl. 65/17.4

(57) ABSTRACT

For improving the refractive index homogeneity of quartz glass bodies, at least one burner is disposed movably in a melting device with respect to the quartz glass object which is to be produced. The burner has three essentially concentrically disposed groups of nozzles for metering the raw material, supplying the hydrogen and supplying the oxygen. Corresponding to the changes in the distribution of OH and H₂ between the center and the edge of the quartz glass object, the volumes of hydrogen and/or oxygen of the burner gases flowing change as a function of the burner position with respect to the quartz glass object in order to bury the mixing ratio in the burner gas.

The invention relates to an arrangement for improving the homogeneity of quartz glass objects of the type, dealt with in the claims.

It is well known that, for producing quartz glass products with a highly homogenous distribution of refractive indexes over the diameter of the cylinder, it is necessary to ensure a balanced distribution of certain material properties over the diameter of the cylinder. These include the distribution of the physically dissolved hydrogen H₂, as well as that of chemically dissolved water, in the form of OH groups, in the quartz glass. The development of these properties in the quartz glass is determined by such factors as the chemical processes in the burner flame during the deposition, as well as the fusion-determined interactions of the hot melt cap with the surrounding gas atmosphere.

According to the WO 01/27044 A1, the state of the art is the realization of a uniform application and a uniform temperature distribution over the cap by rocking the burner, for which a movement of the burner, relative to the surface of the cap of a quartz glass cylinder, takes place at a constant burner gas volume flow according to certain path-time principles. However, it has turned out that, as a result of thermal and flow differences over the surfaces of the cap, residual inhomogeneities in the quartz glass can occur here and increase naturally, chiefly parabolically, towards the edge of a glass object.

The object of the present invention therefore is a selective change in the chemical processes in the burner flame and optionally their combination with the so-called burner rocking over the cap of the quartz glass object.

Pursuant to the invention, this objective is accomplished by the distinguishing features of claim 1. If the controlled movement of the burner with respect to the cap of the quartz glass object, which is to be melted, is referred to as “burner rocking”, the site-dependent change in the mixing ratio of the burner gases, which preferably are hydrogen and oxygen, can be regarded as “gas rocking”. For varying the burner gas flows, externally mixing burners with concentric annular gaps are particularly suitable. These have a centrally disposed carrier gas nozzle for metering the raw material with an appropriate feed pipe, as well as, preferably, five to nine concentrically disposed annular gap nozzles with appropriate feed pipes, which carry oxygen and hydrogen alternatively, from the inside to the outside. Preferably, all nozzles are disposed concentrically with the carrier gas nozzle. Changing the flow of burner gas brings about significant differences in the contents of OH groups and H₂ molecules in the quartz glass object, which ensure a highly homogeneous distribution of refractive indexes. The distribution of OH groups and H₂ molecules is affected differently by changing the mixing ratio of hydrogen to oxygen of the individual burner nozzles.

Advantageously, only the flow of hydrogen or that of oxygen is varied appropriately in order to change the hydrogen to oxygen mixing ratio. By so doing, it is possible to simplify the control technique. In order to achieve a high OH level and a low H₂ level, the mixing ratio, resulting from changing the hydrogen, should be less than 2.3. Conversely, a low OH level and a high H₂ level result when the internal mixing ratio is greater than 2.8.

By continuously adapting the volume of hydrogen and/or oxygen flowing to the burner position and, with that, the mixing ratios in the burner flame, the OH and H₂ levels can be adjusted during the particle formation so that the variations in OH and H₂ from the center to the edge of the cylinder are largely made homogeneous. The changes in the OH distribution are reduced here to less than 5 ppm and the changes in the hydrogen distribution to values smaller than 5E17 molecules per cc. This leads finally to a homogeneous distribution of refractive indexes in the quartz glass object (dn-PV<+/−0.5 ppm), which satisfies the high optical demands for use as a blank in microlithography as well as for special UV laser applications.

The invention is explained in greater detail below by means of the schematic drawing, in which

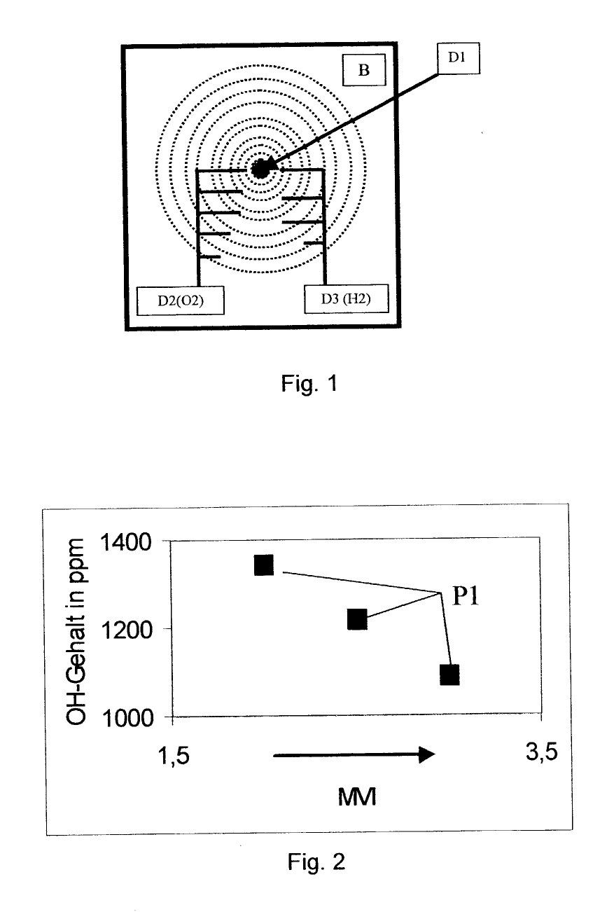

FIG. 1 shows a burner outlet surface in plan view,

FIG. 2 shows a diagram of the OH content as a function of the mixing ratio,

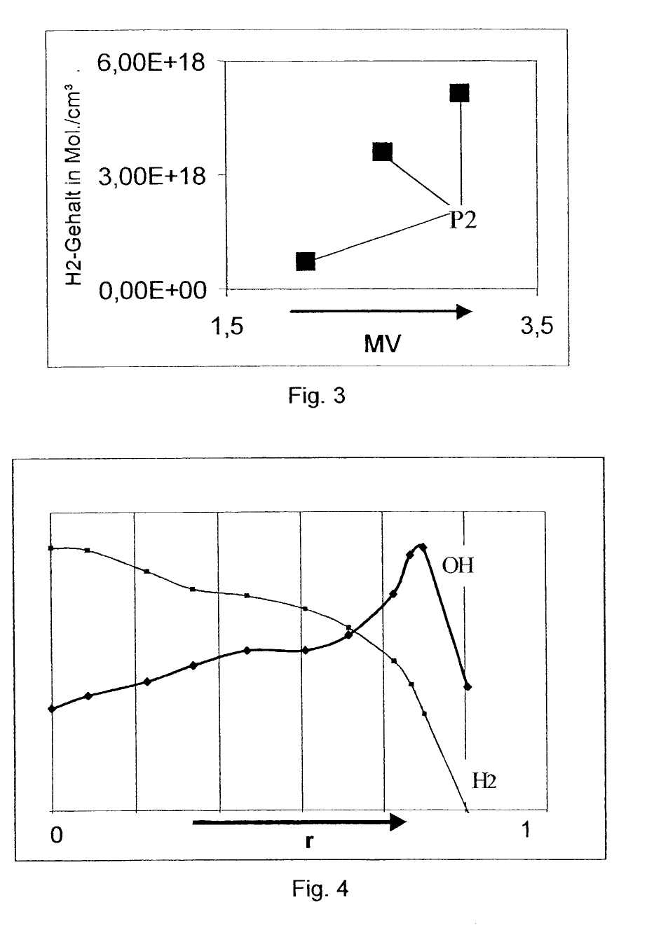

FIG. 3 shows a diagram of the hydrogen content as a function of the mixing ratio,

FIG. 4 shows a diagram of the OH and H₂ distribution over the radius of a quartz glass object for which the invention has not been used,

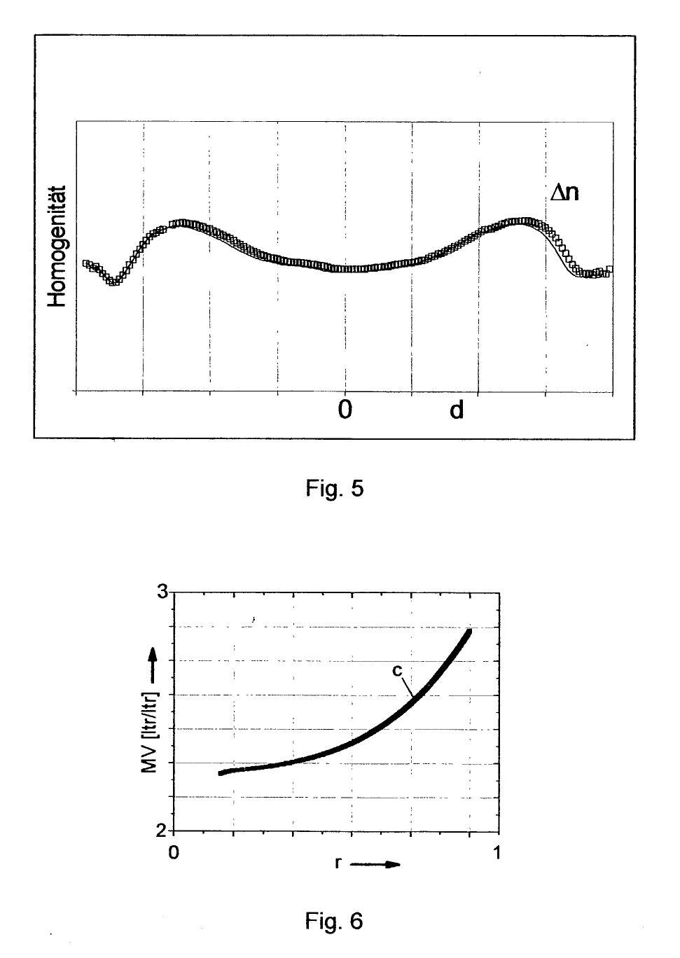

FIG. 5 shows a diagram of the refractive index distribution of FIG. 4,

FIG. 6 shows a diagram of the mixing ratio as a function of the radius,

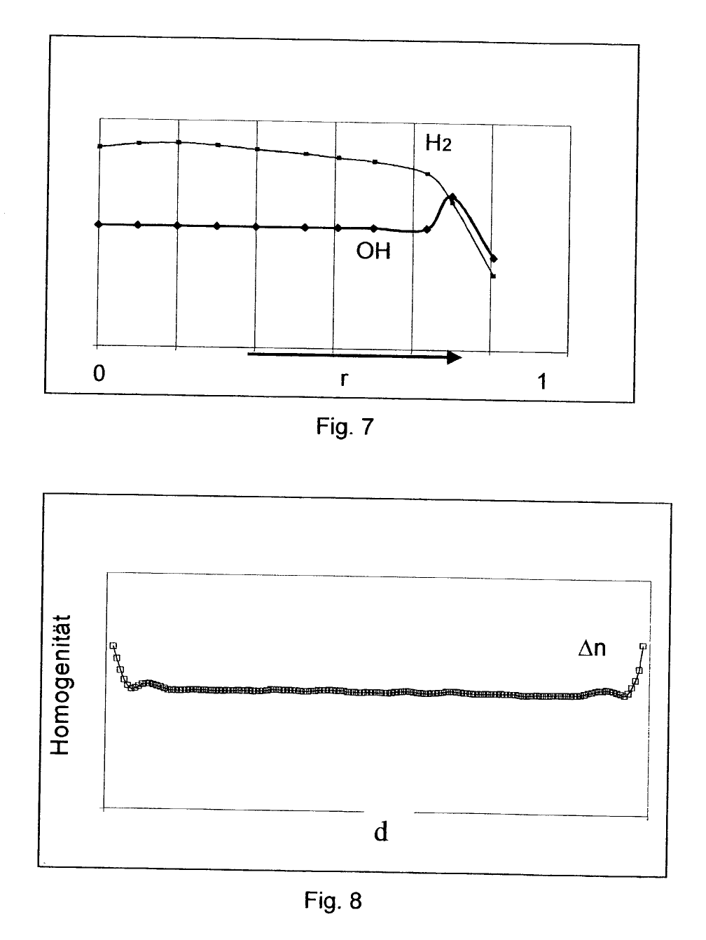

FIG. 7 shows a diagram of the OH and H₂ distributions over the radius of a quartz glass object using the invention and

FIG. 8 shows a diagram of the refractive index distribution of FIG. 7.

In FIG. 1, the outlet surface of a burner B is shown, in which a nozzle D1 for a carrier gas is surrounded concentrically by two to four nozzles for H₂ (D3) and three to five nozzles for O₂ (D2). In general, it may be stated that burner B, for flow reasons, should have at least five to nine annular nozzles. A basic arrangement of the burner in a melting device is shown, for example, in the already mentioned WO 01/27044 A1.

The use of the invention is preceded by precipitation investigations for adjusting the melt system. In particular, it is necessary to ascertain the precipitation characteristics of the burner and to adapt the burner output (total amount of hydrogen) to the dimensional relationships which are to be attained.

In FIG. 2, the OH content in ppm is plotted as a function of the mixing ratio and, in FIG. 3, the hydrogen content in moles/cc is also plotted as a function of the mixing ratio. These were ascertained in precipitation investigations. Since corresponding rows of points P1 and P2 in the diagrams rise and fall in opposite directions, it must be concluded that certain adjustments in the gas values in the burner lead to characteristic property levels in the quartz glass. For example, if the internal mixing ratio MVI is less than 2.3, a high OH level and a low H₂ are obtained; if the internal mixing ratio is greater than 2.8, a low OH level and a high H₂ level are obtained. The technically usable range of variation of the mixing ratio, adjustable by the volumes of gas flowing, lies between 1.6 L/L and 3.5 L/L.

In FIG. 4, the distributions of OH and H₂ are shown as a function of the normalized radius r for a quartz glass object, which was produced without resorting to the invention. The corresponding distribution of refractive indexes Δn is given in FIG. 5, in which the homogeneity of a cylinder-shaped quartz glass object is plotted as a function of the diameter d. It is clear that appreciable fluctuations in the refractive index corresponding to the OH and H₂ distributions prevent the use of a quartz glass object, produced according to the state of the art, for highly accurate purposes without further processing, especially in the edge regions.

In FIG. 6, the mixing ratio MV is plotted as a function of the normalized radius in curve c. For the aimed for, equalized distribution of properties of OH and H₂ on the cap of the quartz glass object, which is not shown, a site-dependent function for the volumes of gas flowing or the mixing ratio of the burner nozzles (D2 and D3 in FIG. 1) is obtained from the precipitation investigations.

From FIGS. 7 and 8, the OH and H₂ distributions as well as the corresponding refractive index distribution nv are plotted as a function of the radius or diameter in corresponding quartz glass objects after use of the invention (gas rocking). By means of the site-dependent change in the mixing ratio of hydrogen to oxygen in the burner flame from 1.8 L/L to 2.4 L/L, the OH level is lowered and the H₂ level raised at the edge of the quartz glass object in comparison to FIG. 4. From the site-dependent change in the volumes of gas flowing and, with that, in the mixing ratio of hydrogen to oxygen, the smoothened course of the refractive index Δn of FIG. 8 results.

1. An arrangement for improving the refractive index homogeneity of quartz glass objects, for which, in a melting device, at least one burner is disposed movably with respect to the quartz glass object, which is to be produced, and the burner has three essentially concentrically disposed groups of nozzles for metering the raw material, supplying the hydrogen and supplying the oxygen, wherein, corresponding to the changes in the distribution of OH and H₂ between the center and the edge of the quartz glass object, the volumes of hydrogen and/or oxygen of the burner gases flowing changes as a function of the burner position with respect to the quartz glass object in order to vary the mixing ratio in the burner gas.

2. The arrangement of claim 1, wherein only the volume of hydrogen flowing is changed in order to change the mixing ratio.

3. The arrangement of claim 1, wherein only the volume of oxygen flowing is changed in order to change the mixing ratio.
